(19) United States
(12) Patent Application Publication
(10) Pub. No.: US 2013/0322333 A1
(43) Pub. Date: Dec. 5, 2013

(54) NETWORK SERVER, MOBILE COMMUNICATIONS DEVICE, AND METHOD THEREOF

(71) Applicant: MEDIATEK INC., Hsin-Chu (TW)

(72) Inventor: Jeng-Yi TSAI, Hsinchu City (TW)

(73) Assignee: MediaTek Inc., Hsin-Chu (TW)

(21) Appl. No.: 13/893,518

(22) Filed: May 14, 2013

Related U.S. Application Data
(60) Provisional application No. 61/653,597, filed on May 31, 2012.

(51) Int. Cl. H04W 4/00

(52) U.S. Cl. CPC H04W 4/00
USPC 370/328

(57) ABSTRACT

A network server and method thereof are provided. The method performed by a network server includes receiving a first data from a first radio frame on a UL DPDCH, despreading the first data with a fixed spreading factor, de-rate matching the despreaded first data with a plurality of de-rate matching schemes, and determining a transport format of the first data that is being used based on all decoded data.

### CROSS REFERENCE TO RELATED APPLICATIONS

This application claims priority of U.S. Provisional Application No. 61/653,597, filed on May 31^{st}, 2012, and the entirety of which is incorporated by reference herein.

### BACKGROUND OF THE INVENTION

1. Field of the Invention

The present invention relates to a Universal Mobile Telecommunications System Frequency-Division Duplexing (UMTS FDD) communications system, and in particular, relates to a network server, mobile communications device, and method thereof in a UMTS FDD communications system.

2. Description of the Related Art

In a Universal Mobile Telecommunications System Frequency-Division Duplexing (UMTS FDD) environment such as a Universal Mobile Telecommunications System (UMTS), a blind transport format detection (BTFD) can be utilized to determine a transport format for decoding received data, leading to increased system capacity.

### BRIEF SUMMARY OF THE INVENTION

A detailed description is given in the following embodiments with reference to the accompanying drawings.

An embodiment of a method performed by a network server is described, comprising: receiving a first data from an uplink dedicated data physical channel (UL DPDCH); despreading the first data with a plurality of spreading factors; and determining a transport format of the first data that is being used based on all despreaded data, wherein the first data has a variable data rate.

Another embodiment of a method performed by a network server is provided, comprising: receiving a first data from a first radio frame on a UL DPDCH; despreading the first data with a fixed spreading factor; de-rate maching the despreaded first data with a plurality of de-rate matching schemes; and determining a transport format of the first data that is being used based on all decoded data.

Another embodiment of a method performed by a mobile communications device is disclosed, comprising rate matching a first data to a fixed data length; spreading the rate matched first data with a fixed spreading factor; and transmitting the spreaded data on a UL DPDCH.

Another embodiment of a method performed by a mobile communications device is revealed, comprising generating a radio frame which only consists of a pilot data, a feedback indication (FBI) data, and a transmit power control (TPC) data; and transmitting the radio frame on an uplink dedicated control physical channel (UL DPCCH).

### BRIEF DESCRIPTION OF THE DROWINGS

The present invention can be more fully understood by reading the subsequent detailed description and examples with references made to the accompanying drawings, wherein:

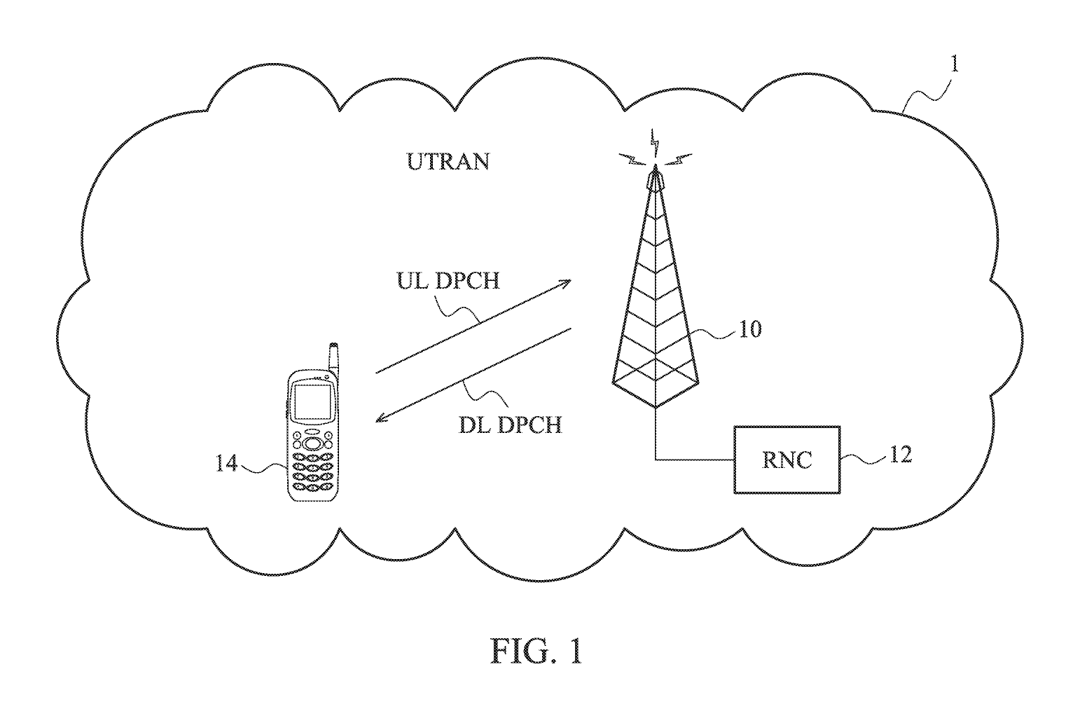

FIG. 1 is a system diagram of a UTRAN in a UMTS according to an embodiment of the invention.

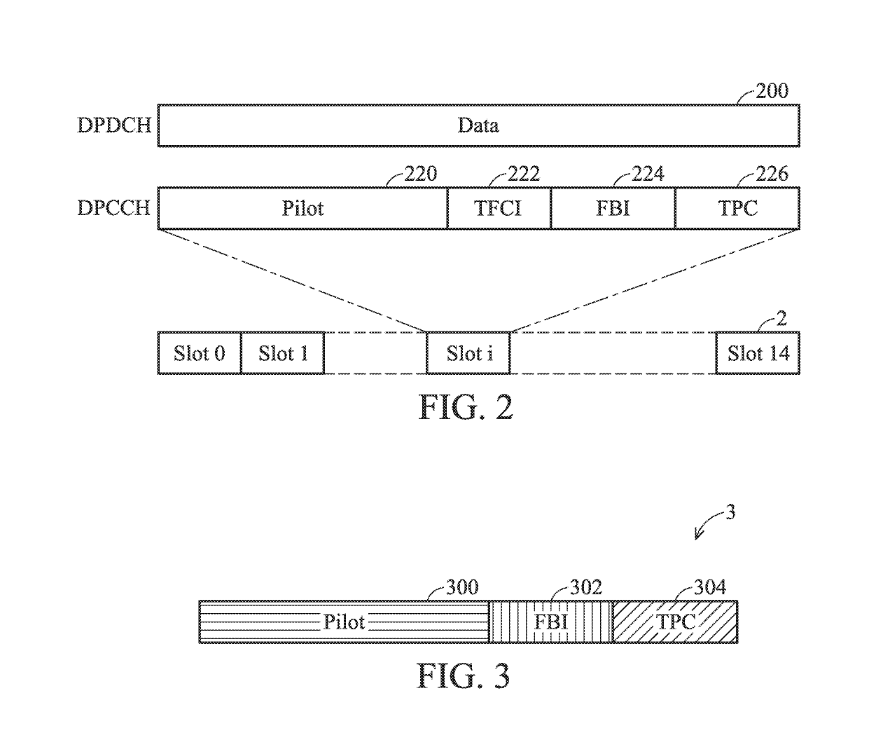

FIG. 2 illustrates the slot configurations of a radio frame for 3GPP Release 99 uplink DPCH.

FIG. 3 illustrates a slot format of a UL DPCCH slot according to an embodiment of the invention.

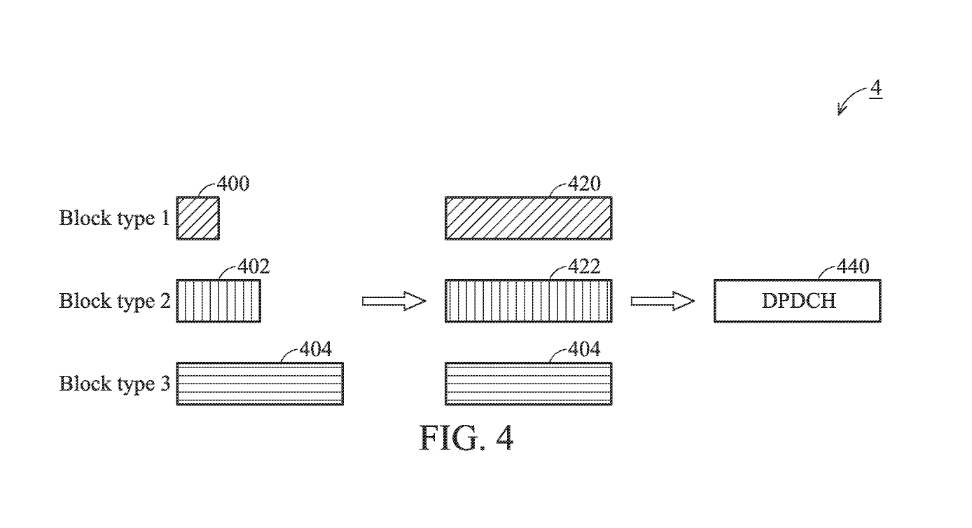

FIG. 4 depicts a fixed data length method according to an embodiment of the invention.

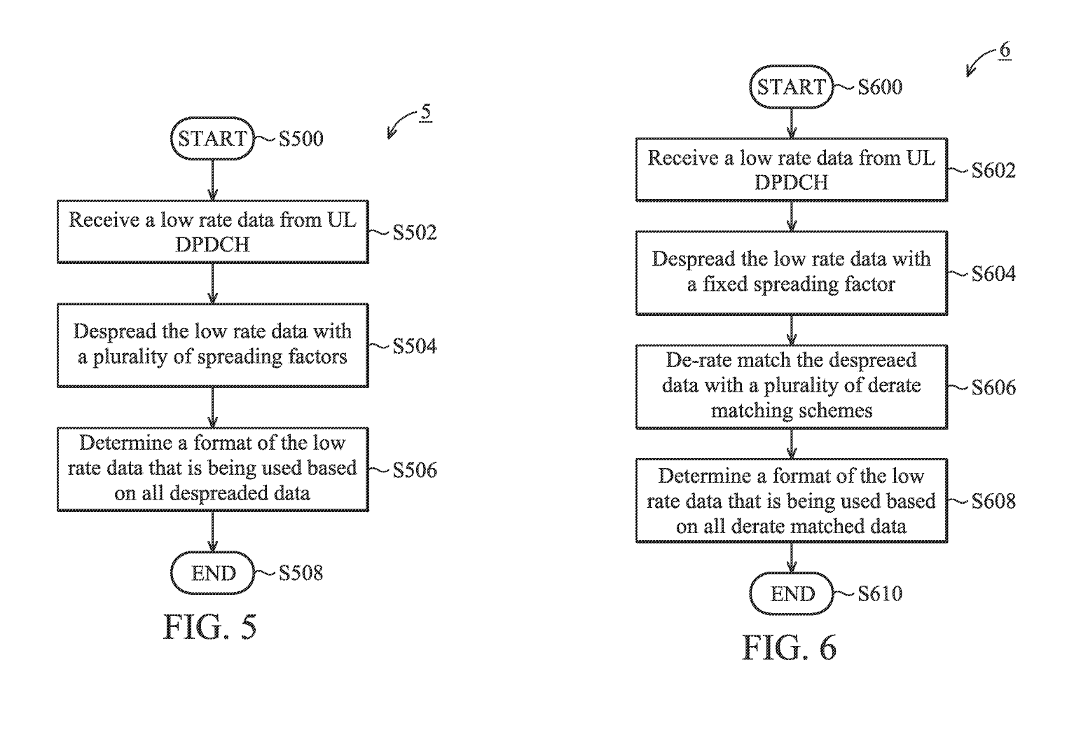

FIG. 5 is a flowchart of a blind detection method performed by a node B station according to an embodiment of the invention.

FIG. 6 is a flowchart of a blind detection method performed by a node B station according to another embodiment of the invention.

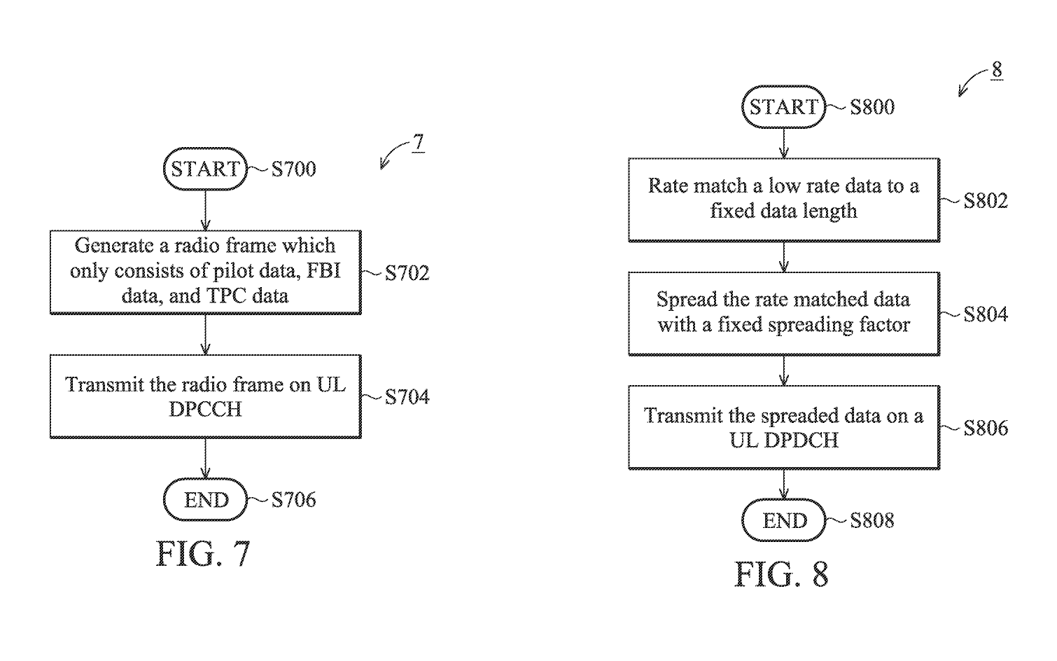

FIG. 7 is a flowchart of an uplink DPCCH data generation method 7 performed by a UE device according to an embodiment of the invention.

FIG. 8 is a flowchart of an uplink DPDCH data generation method 8 performed by a UE device according to an embodiment of the invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Since 1999, 3rd Generation Partnership Project (3GPP) relasesed several versions of spread-spectrum-based mobile communications system, including Universal Mobile Telecommunications Systems (UMTS), High-Speed Packet Access (HSPA), and High-Speed Packet Access+(HSPA+). The following discussions are based on UMTS Frequency-Division Duplexing (FDD) communications system, which is also called Release 99 FDD to discriminate from those new features in later releases. We will illustrate various features and benefits of the disclosed power control methods, devices and systems.

FIG. 1 is a system diagram of a UMTS Terrestrial Radio Access Network (UTRAN) 1 in a UMTS according to an embodiment of the invention, comprising a Node B 10 and a radio network controller (RNC) 12. For a circuit switched service such as a voice or speech service, a user equipment (UE) 14 can communicate with the node B 10 by communications channels including an uplink dedicated physical channel (UL DPCH) and a downlink dedicated physical channel (DL DPCH). The UE 14 may be a notebook computer with a dongle device, a mobile phone, or other mobile communications device capable of perform wireless communications with the UTRAN 1. The RNC 12 is connected to and controls a plurality of Node Bs. The Node B 10 includes a transmitter (not shown), a receiver (not shown) and a control circuit (not shown).

The UTRAN 1 implements a blind transport format detection (BTFD) scheme for the circuit switched service on the Node B 10 according to various embodiments of the invention, as detailed by FIG. 3 through FIG. 6. The BTFD scheme implemented in the Node B 10 is briefly explained as follows. The Node B 10 is configured to determine a transport format or a slot format of a circuit switched data either by pre-despreading the received data with a plurality of possible spreading factors then perform de-rate matching to each pre-desrepaded data with a specific de-rate matching scheme corresponding to each possible spreading factor, or by pre-despreading the received data with a fixed spreading factor and then apply de-rate matching to the despreaded data with a plurality of de-rate matching schemes. In either cases, the Node B 10 can determine a correct slot format for the circuit switched data based on de-rate matched data. Because the BTFD method is implemented in the Node B 10, a transport format combination indicator (TFCI) indicating a combination of rate matching scheme and a channel coding scheme is no longer required in a control slot on the uplink DPCH.

In the case of a speech data, each speech data is transmitted over 2 radio frames on the uplink and downlink DPCHs, which indicates how often data arrive from the higher layers to a physical layer. The BTFD method implemented on the Node B 10 can decide a format for the received speech data by processing the received speech data by embodiments and methods introduced in FIGS. 3 through 6.

FIG. 2 illustrates the slot configurations of a radio frame for 3GPP Release 99 uplink DPCH, containing a dedicated physical data channel (DPDCH) radio frame and a dedicated physical control channel (DPCCH) radio frame multiplexed orthogonally by an in-phase (I) and a quadrature (Q) component. Each DPCCH and DPDCH radio frame contains 15 time slots within 10 ms. The DPCCH radio frame is used to transfer physical layer control information.

The DPCCH radio frame includes a Pilot field 220, a TFCI field 222, a feedback information (FBI) field 224, and a transmit power control (TPC) field 226. The Pilot field 220 contains pilot bits which allow the Node B 10 to maintain synchronization and to provide the channel estimation as well as the downlink transmit power control (TPC). More specifically, the pilot bits are used by the receiver of the Node B 10 to determine a Signal-to-Interference Ratio (SINR) which is then compared with the uplink target SINR for generating a downlink TPC command. The TPC command is then included in the TPC field 226 for the downlink inner loop power control, instructing the Node B 10 to either increase or decrease their transmission powers. The TFCI field 222 is optional, and contains a TFCI data to inform the Node B 10 of the transport combination at any instant of time. When the TFCI data is absent from the radio frame, the Node B 10 has to perform a blind detection of the transport format combination by CRC check results. In the 3GPP Release 99, the blind detection is only implemented for a fixed rate data. The FBI field 224 includes an FBI data for closed-loop downlink transmission diversity mode or for site selection diversity transmit mode.

Before being transmitted over the UL DPCH, the uplink DPDCH and DPCCH radio frames on the I and Q components are separately multiplied by different spreading codes, and then multiplied by UE-specific scrambling codes to separate transmission for different UEs in the cell coverage. The spreading factor of spreading code for the DPDCH radio frames may range from 4 to 256. The spreading factor of spreading code for the DPCCH radio frames may be 256. The spreading factor on the DPDCH may vary on a frame by frame basis.

FIG. 3 illustrates a slot format 3 of a UL DPCCH slot according to an embodiment of the invention, comprising a Pilot field 300, an FBI field 302 and a TPC field 304. The slot format 3 contains no TFCI data, since a blind detection has been implemented onto the node B 10. In consequence of the removal of the TFCI data, the data length of the Pilot field 300 may be expanded beyond the data length set by the 3GPP Release 99 specification as shown in the table 1 below, where Nₚᵢₗₒₜ, N_{TPC}, N_{TFCI}, N_{FBI} each represents a number of bits in the pilot field, the TPC field, the TFCI field and the FBI field in the uplink slot defined in the 3GPP Release 99.

TABLE 1

| Slot Form | | | | |
|---|---|---|---|---|
| at #i | Nₚᵢₗₒₜ | N_{TPC} | N_{TFCI} | N_{FBI} |
| 0 | 6 | 2 | 2 | 0 |
| 0A | 5 | 2 | 3 | 0 |
| 0B | 4 | 2 | 4 | 0 |
| 1 | 8 | 2 | 0 | 0 |
| 2 | 5 | 2 | 2 | 1 |
| 2A | 4 | 2 | 3 | 1 |
| 2B | 3 | 2 | 4 | 1 |
| 3 | 7 | 2 | 0 | 1 |
| 4 | 6 | 2 | 0 | 2 |
| 5 | 5 | 1 | 2 | 2 |
| 5A | 4 | 1 | 3 | 2 |
| 5B | 3 | 1 | 4 | 2 |

For example, since the TFCI field is removed in the present embodiment, the data length of the pilot field 300 for slot form at #0 may be increased to 8 bits, leading to an increased accuracy in estimating the signal quality for the channel.

As a consequence of the expanded pilot field 300, accuracy of signal quality and channel estimation by the Node B 10 can be increased, resulting in an increased system capacity. In some embodiments where the closed loop transmit diversity (CLTD) and site selection diversity transmit is not applied, the FBI field 302 can also be removed from the slot format, rendering further increased available data space for the pilot field 300 and the TPC field 304. The blind detection method incorporated with the UL DPCCH slot format 3 is detailed in the methods 5 through 8 in FIGS. 5 through 8.

FIG. 4 depicts a rate matching method 4 according to an embodiment of the invention, illustrating how 3 possible data block sizes can be encoded to support a blind detection method for a variable-rate data on the Node B 10. The variable-rate data has a data rate less than 64 k bits per second (bps), and may be a limited block size less than 244 bits, and has a variable data rate. In certain embodiments, the block size may be up to 400 or 500 bits. Further, the variable-rate data contains no discontinuous transmission (DTX) bit on the UL DPDCH. In some embodiments, the variable-rate data is a speech data that has 3 possible slot formats and 3 possible data rates for “speech”, “mute”, or “background noise” (also known as Silence Insertion Descriptor SID) data which corresponds to a Block type 3, a Block type 2 and a Block type 1 in FIG. 4, respectively. Each data block includes data bits originated from one or more data sources in a continuous or discontinuous manner. The data bits are collected over time to render one of the 3 block types show in FIG. 4.

The Block types 1-3 are different in data length. The UE 14 is configured to take the Block types 1-3 and make them equal in length (fixed data length or fixed data size) by a predetermined repetition pattern, or simply repeating the block data until a fixed data length is filled. For example, the UE 14 can directly repeat the block 400 four times to derive a encoded block 420, repeat the block 402 twice to produce the encoded block 422, and retain the block 404 as it is, resulting in the three blocks 420, 422 and 404 which are equal in data length. The UE 14 can then carry on to apply a fixed spreading code to the encoded blocks 420, 422 and 404 and transmit the spreaded data over the uplink DPDCH to the Node B 10. The fixed data length may be the maximal data length among all available data lengths. For example, the fixed data length in FIG. 4 is the data length of the Block type 3.

In some embodiments, the UE 14 can apply a bit-by-bit repetition to the block data until the fixed data length is reached. For example, the UE 14 can repeat the block 402 in a bit-by-bit manner and each bit is repeated twice to generate the encoded block 422. In some embodiments, the UE 14 can apply a multibit-by-multibit repetition to the block data until the fixed data length is reached. For example, the UE 14 can repeat the block 402 in a 2 bits-by-2 bits manner and each 2 bits is repeated twice to generate the encoded block 422. In some other embodiments, the UE 14 can apply a random block repetition until the fixed data length is reached.

The rate matching method 4 is adopted by the UE 14 to provide a fixed-length data block which can be used in a blind detection method 6 in FIG. 6.

FIG. 7 is a flowchart of an uplink DPCCH data generation method 7 performed by a UE device (mobile communications device) according to an embodiment of the invention, incorporating the UE 14 in FIG. 1. The uplink DPCCH data generation method 7 is applied to the uplink DPCCH data by the UE 14, and can incorporate the blind detection method 5 or 6 in a UMTS FDD system.

Upon initialization (S700), the UE 14 is configured to generate a control radio frame which consists of only the pilot data, the FBI data and the TPC data (S702). There is no TFCI data in the control radio frame. The pilot data may have a data length exceeding that is defined in the 3GPP Release 99 standard to provide an increased channel estimation and synchronization performance. Next, the UE 14 is configured to transmit the control radio frame over the uplink DPCCH to the Node B 10 (S704) and the uplink DPCCH data generation method 7 is completed and exited (S706). Although the TFCI data is absent from the control radio frame, the Node B 10 is still able to determine the transport format of the user data on the uplink DPDCH based on the BTFD schemes outlined in the blind detection method 5 or 6, as detailed in FIGS. 5 and 6. The UE 14 may transmit the user data using a data radio frame on the uplink DPDCH. The user data is a low rate data with a data rate less than 64 k bps. The user data may be spreaded by a variable spreading factor or a fixed spreading factor prior to the uplink data transmission. In the case of the variable spreading factor, the UE 14 is configured to determine a rate matched data length and a corresponding spreading factor based on block type of the user data. Accordingly, the UE 14 is next configured to rate match the user data to the rate matched data length and the spread the rate matched data with the corresponding spreading factor, resulting in the data radio frame to be delivered over the uplink DPDCH. In the case of the fixed spreading factor, the UE 14 employs a fixed rate matched data length and a fixed spreading factor irrespective of the block type of the user data. The UE 14 is configured to rate match the user data to the fixed rate matched data length and then spread the rate matched data with the fixed spreading factor to produce the data radio frame. Details for the data spreading method with a fixed spreading factor are provided in the uplink DPDCH data generation method 8 in FIG. 8.

FIG. 8 is a flowchart of an uplink DPDCH data generation method 8 performed by a UE device (mobile communications device) according to an embodiment of the invention, incorporating the UE 14 in FIG. 1. The uplink DPDCH data generation method 8 is applied to the uplink DPDCH data by the UE 14, and can incorporate the blind detection method 6 in a UMTS FDD system.

Upon initialization (S800), the UE 14 is ready to transmit a user data on the uplink DPDCH. The uplink DPDCH data generation method 8 utilizes a fixed rate matched data length and a fixed spreading factor. The UE 14 is configured to rate match the user data (low rate data) to the fixed rate matched data length (fixed data length) (S802), spread the rate matched data with the fixed spreading factor to produce the data radio frame (S804), and transmit the data radio frame over the uplink DPDCH to the node B 10 (S806), where the data radio frame will be decoded by the blind detection method 6 detailed in FIG. 6. The uplink DPDCH data generation method 8 is then completed and exited (S806). The fixed spreading factor may be a minimal spreading factor defined in the 3GPP Release 99 specification, or the fixed spreading factor may be 4. The fixed rate matched data length may be a maximal data length defined in the 3GPP Release 99 specification.

FIG. 5 is a flowchart of a blind detection method 5 according to an embodiment of the invention, incorporating the node B 10 in FIG. 1.

Upon startup, the Node B 10 is initiated to detect radio frames on the uplink DPCH (S500). The receiver of the Node B 10 can detect and receive a first radio frame on the uplink DPCH, which contains DPCCH slots and DPDCH slots. In the embodiment, the TFCI data is eliminated from the DPCCH slot, as depicted in the DPCCH slot 3 in FIG. 3, thus a blind detection is implemented into the Node B 10 to determine a transport format or slot format for a low rate data. The low rate data is a circuit switched data. The low rate data has a data rate less than 64 k bits per second (bps) and a limited block size less than 244 bits, and may have a variable data rate. In some embodiments, the low rate data is a speech data that has the 3 possible slot formats and 3 possible data rates.

Upon receiving the low rate data (first data) from a DPDCH slot of the first radio frame on the UL DPCH (S502), the control circuit of the Node B 10 is configured to pre-despread the low rate data with a plurality of possible spreading factors (S504). The number of the possible spreading factors may range from 1 to 7, that is, the control circuit of the Node B 10 can concurrently despread the low rate data with up to 7 different spreading factors and buffer the despreaded data in a local memory. In the example of the 12.2 k bps speech data, the control circuit of the Node B10 is configured to despread the low rate data with the 3 possible spreading factors, i.e. 64, 128 and 256 and buffer the despreaded results into the local memory in the control circuit of the Node B 10.

Based on the despreaded data in the local memory, the control circuit of the Node B 10 can proceed to determine a correct slot format for the received low rate data (S506). In some embodiments, the control circuit is configured to determine the correct slot format by an error detection coding scheme such as a cyclic redundancy check (CRC), a parity bit, a checksum, a repetition code, or other error correcting codes. Before applying the error detection coding scheme, the control circuit of the Node B 10 can apply various signal processes such as de-rate matching and deinterleaving to the three buffered despreaded data. The control circuit can apply the CRC on the three signal processed data to derive corresponding CRC results (accuracy), and based on the CRC results, determine which one of the three despreaded data has a correct slot format that is being used by the low rate data. The correct slot format will show no error in the CRC results. In other embodiments, the control circuit is configured to determine the correct slot format based on a data quality metric derived during the channel decoding. For example, the control circuit is configured to decode all three despreaded data by a convolutional code to determine convolutional code metrics that rank the degree of the correctness in the three despreaded data, and based on the convolutional code metrics (accuracy), determine which one of the three despreaded data has a correct slot format that is being used by the low rate data. The correct slot format will display a highest rank in the convolutional code metrics.

After the correct slot format for the low rate data is determined, the blind detection method 5 is completed and exited (S508).

The blind detection method 5 pre-despreads a variable-rate data by two or more possible spreading codes, and determines a correct slot format for the variable-rate data based on the pre-despreaded results, thereby reducing the uses of the TFCI information on the UL DPCCH, and increasing data space for the pilot data on the UL DPCCH, leading to an increased accuracy in signal quality estimation and channel estimation, and an improvement in the system capacity.

FIG. 6 is a flowchart of a blind detection method 6 according to another embodiment of the invention, incorporating the Node B 10 in the FIG. 1.

Upon startup, the Node B 10 is initiated to detect radio frames on the uplink DPCH (S600). The receiver of the node B 10 can detect and receive a first radio frame on the uplink DPCH, which contains DPCCH slots and DPDCH slots. In the embodiment, the TCFI data is eliminated from the DPCCH slot, as depicted by the DPCCH slot 3 in FIG. 3, thus a blind detection is implemented into the Node B 10 to determine a transport format or slot format for a low rate data. The low rate data has a data rate less than 64 k bps and a limited block size less than 244 bits. The low rate data is a circuit switched data. In some embodiments, the low rate data is a speech data that has the 3 possible slot formats.

Upon receiving the low rate data (first data) from a DPDCH slot of the first radio frame on the UL DPCH (S602), the control circuit of the Node B 10 is configured to despread the low rate data with a fixed spreading factor (S604). The fixed spreading factor may be a minimal spreading factor defined in the 3GPP Release 99 specification, or the fixed spreading factor may be 4.

Based on the despreaded data, the control circuit of the Node B 10 can proceed to perform de-rate matching on the despreaded data with a plurality of de-rate matching schemes (S606). More specifically, each decoding scheme may involve decoding the despreaded data with a different number of repeated bits or a different repetition pattern. Accordingly, the coding schemes in FIG. 4 applies the bit-by-bit repetition, the multibit-by-multibit repetition, the random block repetition, or other repetition patterns for different data block size of the speech data. Therefore, the corresponding decoding schemes will separate the despreaded data according to the bit-by-bit repetition, the multibit-by-multibit repetition, the random block repetition, or other repetition patterns. In the example of the speech data, the control circuit of the Node B 10 is configured to de-rate match the despreaded data by 3 different repetition patterns to recover 3 block types of de-rate matched data, and buffer the 3 de-rate matched data in a local memory in the Node B 10.

Next, based on all de-rate matched data, the control circuit of the Node B 10 can determine a correct slot format for the received low rate data (S608). In some embodiments, the control circuit is configured to determine the correct slot format by an error detection coding scheme such as a cyclic redundancy check (CRC), a parity bit, a checksum, a repetition code, or other error correcting codes. For example, the control circuit can apply the CRC on the three buffered decoded data, and based on the CRC results, which represents accuracy of the de-rate matched data, the control circuit can determine which one of the three decoded data has a correct slot format that is being used by the low rate data. The correct slot format will show no error in the CRC results. In other embodiments, the control circuit is configured to determine the correct slot format based on a data quality metric derived during the channel decoding. For example, the control circuit is configured to decode all three de-rate matched data by a convolutional code to determine convolutional code metrics that rank the degree of the correctness in the three de-rate matched data, and based on the convolutional code metrics, which represents accuracy of the de-rate matched data, the control circuit can determine which one of the three de-rate matched data has a correct slot format that is being used by the low rate data. The correct slot format will display a highest rank in the convolutional code metrics.

After the correct slot format for the low rate data is determined, the blind detection method 6 is completed and exited (S610).

The blind detection method 6 employs a fixed spreading code to determine a correct slot format for a low rate data on the UL DPDCH, thereby reducing the uses of the TFCI information on the UL DPCCH, and increasing data space for the pilot data on the UL DPCCH, leading to an increased accuracy in signal quality estimation and channel estimation, and an improvement in the system capacity.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method, performed by a network server, comprising:
receiving a first data from an uplink dedicated data physical channel (UL DPDCH);
despreading the first data with a plurality of spreading factors; and
determining a transport format of the first data that is being used based on all despreaded data,
wherein the first data has a variable data rate.

2. The method of claim 1, further comprising:
receiving a second radio frame on an uplink dedicated control physical channel (UL DPCCH), wherein the second radio frame contains only a pilot data, a feedback indication (FBI) data, and a transmit power control (TPC) data.

3. The method of claim 1, wherein the determining step comprises:
determining accuracy for each despreaded data based on an error detection scheme; and
determining the transport format of the first data based on the accuracy.

4. The method of claim 1, wherein the first data is a circuit switched data.

5. A method, performed by a network server, comprising:
receiving a first data from a first radio frame on a UL DPDCH;
despreading the first data with a fixed spreading factor;
de-rate matching the despreaded first data with a plurality of de-rate matching schemes; and
determining a transport format of the first data that is being used based on all decoded data.

6. The method of claim 5, wherein the despreaded first data includes a repeated data pattern.

7. The method of claim 5, wherein the de-rate matching step comprises de-rate matching the despreaded first data based on a repetition pattern.

8. The method of claim 5, wherein the determining step comprises:
determining accuracy for each decoded data based on an error detection scheme; and
determining the transport format of the first data based on the accuracy.

9. The method of claim 5, further comprising:
receiving a second radio frame on a UL DPCCH, wherein the second radio contains only a pilot data, a feedback indication (FBI) data, and a transmit power control (TPC) data.

10. The method of claim 5, wherein the first data is a circuit switched data.

11. A method performed by a mobile communications device, comprising:
generating a radio frame which only consists of a pilot data, a feedback indication (FBI) data, and a transmit power control (TPC) data; and
transmitting the radio frame on an uplink dedicated control physical channel (UL DPCCH).

12. The method of claim 11, further comprising:
rate matching a first data to a fixed data length;
spreading the rate matched first data with a fixed spreading factor; and
transmitting the spreaded data on a UL DPDCH.

13. A method performed by a mobile communications device, comprising:
rate matching a first data to a fixed data length;
spreading the rate matched first data with a fixed spreading factor; and
transmitting the spreaded data on a UL DPDCH.

14. The method of claim 13, further comprising:
transmitting a radio frame on an uplink dedicated control physical channel (UL DPCCH);
wherein the radio frame only consists of a pilot data, a feedback indication (FBI) data, and a transmit power control (TPC) data.
